(19) United States
(12) Patent Application Publication
(10) Pub. No.: US 2006/0188662 A1
(43) Pub. Date: Aug. 24, 2006

(54) Ionic mesogenic compounds

(76) Inventors: Louise Diane Farrand, Dorset (GB); Julian Vanghan-Spickers, Southampton (GB); Chris Hardacre, Hardacre (IE); Oonagh Sheppard, Bushy (GB)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/543,157

(22) PCT Filed: Dec. 18, 2003
(86) PCT No.: PCT/EP03/14537

§ 371 Date: Apr. 17, 2006

(30) Foreign Application Priority Data
Jan. 24, 2003 (EP) 03001594.4

(51) Int. Cl. C09K 19/34; C09K 19/58; C09K 19/52; C09K 19/38

(52) U.S. Cl. 428/1.1; 252/299.01; 252/299.2; 252/299.61

(57) ABSTRACT

The invention relates to ionic mesogenic or liquid crystal compounds, and to their use in liquid crystal media, liquid crystal devices, anisotropic polymers, optical, electrooptical, decorative, security, cosmetic, diagnostic, electric, electrochemical, electronic, charge transport, semiconductor, optical recording, electroluminescent, photoconductor, electrophotographic and lasing applications, and to liquid crystal media, polymers, optical components, displays, electrolytes, electrochemical cells and decorative or security markings comprising the ionic compounds.

### FIELD OF THE INVENTION

The invention relates to ionic mesogenic or liquid crystal compounds, and to their use in liquid crystal media, liquid crystal devices, anisotropic polymers, optical, electrooptical, decorative, security, cosmetic, diagnostic, electric, electrochemical, electronic, charge transport, semiconductor, optical recording, electroluminescent, photoconductor, electrophotographic and lasing applications. The invention further relates to liquid crystal media, polymers, optical components, displays, electrolytes, electrochemical cells and decorative or security markings comprising the ionic compounds.

### BACKGROUND AND PRIOR ART

Liquid crystal (LC) compounds are known in prior art and have found widespread use, for example in liquid crystal display (LCD) applications. LC compounds with a polymerizable group can be used for example for the preparation of polymer films with anisotropic properties. Many of these compounds contain a polar group and exhibit a strong permanent dipole moment, so that they can be oriented in an externally applied electric field. In many applications processing of the LC materials, e.g. into films or other components, requires that they are used in a mixture or dissolved in an organic solvent.

It is desirable to have available water soluble LC materials, as these allow largely aqueous solution processing, during, for example, a polymerization process. This improvement ensures that processing is both safer and environmentally cleaner than conventional methods, which employ large quantities of organic solvent. This can be achieved by providing ionic LCs comprising a cation and an anion, which are more water-soluble than their non-ionic equivalents. Moreover, ionic LCs can be used for other applications, like e.g. electrolyte materials for batteries.

Ionic liquid crystal compounds and their use in electrolyte compositions and electrochemical cells are described for example in EP 1 116 769 and EP 1 033 731. However, the compounds disclosed in these documents do not always exhibit the desired LC properties, are not easily synthesized and are relatively expensive.

The invention has the aim of providing ionic LC compounds having favourable properties, like a wide LC phase range, low vapour pressure, and low flammability, but not having the disadvantages of the compounds of prior art as discussed above. Another aim of the invention is to extend the pool of ionic LC compounds available to the expert. Further aims are immediately evident to the person skilled in the art from the following detailed description.

It was found that these aims can be achieved by providing ionic mesogenic or LC compounds according to claim 1.

### SUMMARY OF THE INVENTION

The invention relates to ionic mesogenic or ionic liquid crystalline (LC) compounds comprising at least one organic cation D⁺ that is linked to a mesogenic group MG, optionally via a spacer group Sp¹, or is part of the mesogenic group MG.

The invention further relates to ionic compounds of formula I
R—MG—Sp¹-D⁺E⁻ I
wherein
D⁺ is an organic cation,
E⁻ is an anion,
Sp¹ is a spacer group or a single bond,
MG is a mesogenic group,
R is H, F, Cl, Br, I, CN, NO₂, NCS, SF₅ or alkyl which is straight chain or branched, has 1 to 20 C-atoms, is unsubstituted, mono- or polysubstituted by F, Cl, Br, I or CN, and in which one or more non-adjacent CH₂ groups are optionally replaced, in each case independently from one another, by —O—, —S—, —NH—, —NR⁰—, —SiR⁰R⁰⁰—, —CO—, —COO—, —OCO—, —OCO—O—, —S—CO—, —CO—S—, —CY¹═CY²— or —C≡C— in such a manner that O and/or S atoms are not linked directly to one another, or denotes P-Sp²,
R⁰ and R⁰⁰ are independently of each other H or alkyl with 1 to 12 C-atoms,
Y¹ and Y² are independently of each other H, F, Cl or CN,
P is a polymerizable or reactive group, and
Sp² is a spacer group or a single bond.

The invention further relates to an LC medium containing at least one ionic compound according to the present invention.

The invention further relates to a polymerizable LC medium comprising at least one ionic compound according to the present invention.

The invention further relates to a polymerizable LC medium comprising at least one ionic compound according to the present invention and at least one polymerizable mesogenic compound, which can be said ionic compound and/or an additional compound.

The invention further relates to a linear or crosslinked anisotropic polymer obtained by polymerizing a polymerizable ionic compound or a polymerizable LC medium according to the present invention.

The invention further relates to a linear or crosslinked anisotropic polymer obtained by polymerizing a polymerizable ionic compound or a polymerizable LC medium according to the present invention in its oriented state, preferably an anisotropic polymer film obtained from a layer of said polymerizable material.

The invention further relates to the use of a ionic compound, LC medium, polymer or polymer film as described above and below in electrooptical displays, liquid crystal displays, optical films, polarizers, compensators, beam splitters, reflective films, alignment layers, colour filters, holographic elements, hot stamping foils, coloured images, decorative or security markings e.g. for consumer objects or documents of value, LC pigments, adhesives, synthetic resins with anisotropic mechanical properties, cosmetics, diagnostics, nonlinear optics, optical information storage, as chiral dopants, in electronic devices like for example field effect transistors (FET) as components of integrated circuitry, as thin film transistors in flat panel display applications or for Radio Frequency Identification (RFID) tags, or in semiconducting components for organic light emitting diode (OLED) applications, electroluminescent displays or backlights' of LCDs, for photovoltaic or sensor devices, in lasing applications and devices, as electrolyte materials, in electrochemical cells or batteries, as photoconductors, for electrophotographic applications or electrophotographic recording or as lubricants.

The invention further relates to an LC device comprising a ionic compound, LC medium, polymer or polymer film as described above and below.

The invention further relates to a device utilizing the Kerr effect and comprising a ionic compound, LC medium, polymer or polymer film as described above and below.

The invention further relates to an electrolyte medium comprising a ionic compound, LC medium or polymer as described above and below.

The invention further relates to an electrochemical cell comprising a ionic compound, LC medium, polymer or an electrolyte medium as described above and below.

Definition of Terms

The terms ‘liquid crystal or mesogenic material’ or ‘liquid crystal or mesogenic compound’ means materials or compounds comprising one or more rod-shaped, lath-shaped or disk-shaped mesogenic groups, i.e., groups with the ability to induce LC phase behaviour. The compounds or materials comprising mesogenic groups do not necessarily have to exhibit an LC phase themselves. It is also possible that they show LC phase behaviour only in mixtures with other compounds, or when the mesogenic compounds or materials, or the mixtures thereof, are polymerized.

The terms ‘polymerizable’ and ‘reactive’ include compounds or groups that are capable of participating in a polymerization reaction, like radicalic or ionic chain polymerization, polyaddition or polycondensation, and reactive compounds or reactive groups that are capable of being grafted for example by condensation or addition to a polymer backbone in a polymeranaloguous reaction.

The term ‘film’ includes self-supporting, i.e., free-standing, films that show more or less pronounced mechanical stability and flexibility, as well as coatings or layers on a supporting substrate or between two substrates.

### DETAILED DESCRIPTION OF THE INVENTION

The ionic compounds according to the present invention are mesogenic or liquid crystalline, i.e. they can induce or enhance mesophase behaviour for example in a mixture with other compounds or exhibit one or more mesophases themselves. It is also possible that they show mesophase behaviour only in mixtures with other compounds, or, in case of polymerizable compounds, when being (co)polymerized. Thus, although the compounds of the present invention themselves do not necessarily have to exhibit a liquid crystalline phase, by being rod shaped they do not diminish some of the physical properties of the LC host (such as melting point and clearing points) in to which they are dissolved.

The compounds according to the present invention have several advantages
they are easy to prepare, also on large scale of several hundred grams, with a broad range of derivatives using standard methods that are known from the literature,
they can be prepared in good yield from cheap, commercially available starting materials,
they are rod-shaped and exhibit a good solubility in LC host mixtures,
they are mesogenic or even liquid crystalline,
they are more water soluble than their non-ionic equivalents, having the advantage of aqueous solution handling which is an important environmental consideration,
they can easily be designed to have a great variety of physical properties, for example, low or high melting and clearing points, low or high dielectric and optical anisotropy and liquid crystal phase, achiral or chiral,
their salts are highly ordered and ionic, and therefore have a high Kerr constant,
they can be polymerized if appropriately substituted.

Ionic LCs, and in particular chiral ionic LCs according to the present invention can be used as a highly ordered medium in which asymmetric reactions can be performed, instead of using expensive chiral induction catalysts. The ionic medium can easily be removed from the non-ionic reactants and recycled.

Room temperature molten salts (ionic liquids) do generally possess a number of unique properties that make them for example ideal battery electrolytes. In particular, they are non-flammable, nonvolatile, chemically inert and they display wide electrochemical windows, high conductivities, and wide thermal operating ranges. Salts obtained from the compounds according to the present invention also exhibit many of these useful characteristics, which makes them suitable for use in electrochemical applications, like for example as battery components.

The compounds of the present invention are furthermore suitable for use in polymerizable mixtures for the preparation of anisotropic polymers or polymer films which can be used as optical films for example in LC devices or as decorative or security images. The polymerizable compounds of the present invention can also be mixed with other monomers. Since the compounds of the present invention are ionic, they are more water soluble, this allows for aqueous solution processing.

In the compounds according to the present invention the cation D⁺ is preferably an optionally substituted aliphatic, alicyclic or aromatic group that optionally contains one or more hetero atoms, preferably selected from N, O and S, and contains a positively charged atom, preferably selected from C and N, or a delocalised positive charge. Especially preferred are groups D⁺ containing a carbenium ion, a quaternary alkylammonium ion or a delocalised positive charge. Further preferred are heterocyclic groups, in particular 5-rings like those selected from imidazole, pyrazole, triazole, oxazole, thiazole, and 6-rings like those selected from pyridine, pyrimidine, pyridazine, pyrazine, triazine, imidazole, pyrazole, oxazole, triazole, all these groups being optionally substituted, preferably by one or more groups R as defined in formula I.

It is also possible that the compounds according to the present invention contain more than one, preferably two or three cations D⁺ which may be identical or different, and which are preferably selected from the preferred groups as described above and below. In another preferred embodiment of the present invention one or more of the cations are part of the mesogenic group MG or the group R in formula I.

Especially preferably are cations D⁺ selected from the following 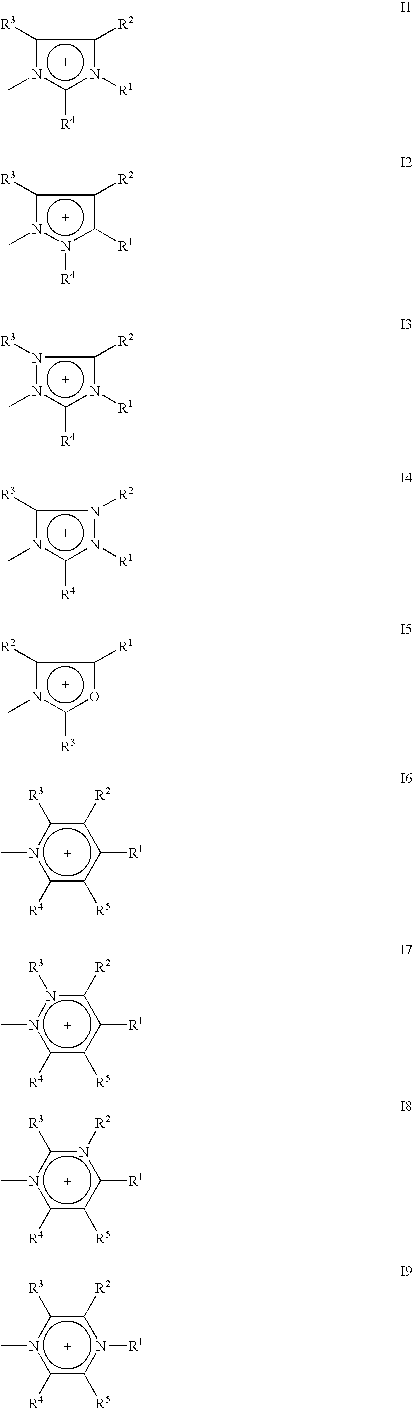
wherein R¹ to R⁵ have independently of each other one of the meanings of R in formula I.
R¹ to R⁵ preferably have independently of each other one of the meanings of R⁰ in formula I, and are preferably H or alkyl with 1 to 5 c atoms, very preferably H, methyl, ethyl or propyl, most preferably H or methyl.

Especially preferred are cations of formula I1, very preferably those wherein R², R³ and R⁴ are H and R¹ is alkyl with 1 to 5 C atoms, very preferably methyl, ethyl or propyl, most preferably methyl.

As anion forming group E⁻ in principle every Lewis acid can be used that is known to the expert and is capable of forming a salt with the cation forming group D. Preferably the anion E⁻ is selected from the group comprising halide anions, phosphate anions, anions containing a C atom like hydrogen carbonate, acetate, trifluoroacetate or lactate, anions containing an N atom like nitrate, nitrite or amide, anions containing an S atom like sulfate, sulfite, alkylsulfate, hydrogensulfate or alkylsulfonate, halide anions containing at least one element selected from the group comprising B, P and S, especially boron or phosporus fluoride anions, oxoanions of metals, and anions based on Se, Te, P, As, Sb or Bi.

Especially preferred anions E⁻ are F⁻, Cl⁻, Br⁻, I⁻, I₃⁻, CH₃COO—, CF₃COO⁻, CF₃(CF₂)₃COO⁻, lactate, NO₃⁻, [(CF₃SO₂)₂N]⁻, [(CF₃CF₂SO₂)₂N]⁻, CF₃SO₃, [CF₃(CF₂)₃SO₃]⁻, [(CF₃SO₂)₃C]⁻, PF₆⁻, AsF₆⁻, SbF₆⁻, BF₄⁻, ClO₄⁻, [P(CₙF₂ₙ₊₁)₆₋ₓFₓ]⁻, Ph₄B⁻ or [(CₙH₂ₙ₊₁)₄B]⁻ wherein x is an integer from 1 to 6 and Ph is phenyl. Most preferably the anion E⁻ is selected from Cl⁻, BF₄⁻ and PF₆⁻.

The mesogenic group MG preferably comprises one or more cyclic groups, very preferably at least two monocyclic groups or at least one bicyclic group comprising at least two fused rings, wherein the rings are preferably selected from 5- and 6-rings.

Very preferably the mesogenic group MG is selected of formula II
-(A²-Z²)ₘ-A¹-Z¹- II
wherein
A¹ and A² are independently of each other an aromatic or alicyclic group, or a group comprising two or more fused aromatic or alicyclic rings, wherein these rings optionally contain one or more hetero atoms selected from N, O and S, and are optionally mono- or polysubstituted by R as defined in formula I,
Z¹ and Z² are independently of each other —O—, —S—, —CO—, —COO—, —OCO—, —S—CO—, —CO—S—, —O—COO—, —CO—NR⁰—, —NR⁰—CO—, —OCH₂—, —CH₂O—, —SCH₂—, —CH₂S—, —CF₂O—, —OCF₂—, —CF₂S—, —SCF₂—, —CH₂CH₂, —CF₂CH₂—, —CH₂CF₂—, —CF₂CF₂—, —CH═N—, —N═CH—, —N═N—, —CH═CR⁰—, —CY¹═CY²—, —C≡C—, —CH═CH—COO—, —OCO—CH═CH— or a single bond, and
m is 0, 1, 2 or 3.

A preferred embodiment of the present invention relates to ionic mesogenic or LC compounds comprising at least one polymerizable group, preferably one or more groups P-Sp² as defined in formula I.

Particularly preferred are compounds of formula I, wherein
Sp¹ is a spacer group with 1 to 5 C atoms or a single bond,
Sp¹ is (CH₂)^{p1}, (CH₂CH₂O)_{q1} or a single bond, with p1 being 1, 2, 3 or 4 and q1 being 1 or 2,
m is equal to or larger than 1,
m is 1 or 2,
MG is a group of formula If wherein Z¹ is —COO—,
R is P-Sp²-,
R is straight chain alkyl or alkoxy with 1 to 12, preferably 1 to 8 C-atoms or alkenyl with 2 to 12, preferably 2 to 7 C-atoms,
Sp² is alkylene with 1 to 12 C atoms which is linked to the neighboured group MG, A¹ or A² via a group selected from —O—, —COO—, —OCO—, —OCOO— or via a single bond,
Sp² is a single bond.

A¹ and A² are independently of each other an aromatic or alicyclic ring, preferably a 5-, 6- or 7-membered ring, or a group comprising two or more, preferably two or three, fused aromatic or alicyclic rings, wherein these rings optionally contain one or more hetero atoms selected from N, O and S, and are optionally mono- or polysubstituted by L, wherein L has one of the meanings of R.

Preferred groups A¹ and A² are for example furan, pyrrol, thiophene, oxazole, thiazole, thiadiazole, imidazole, phenylene, cyclohexylene, cyclohexenylene, pyran, di-or tetrahydropyran, dioxane, dithiane, pyridine, pyrimidine, pyrazine, azulene, indane, naphthalene, tetra- or decahydronaphthalene, anthracene and phenanthrene.

Very preferably A¹ and A² are selected from 1,4-phenylene in which, in addition, one or more CH groups may be replaced by N, 1,4-cyclohexylene in which, in addition, one or two non-adjacent CH₂ groups may be replaced by O and/or S, 1,3-dioxolane-4,5-diyl, 1,4-cyclohexenylene, 1,4-bicyclo-(2,2,2)-octylene, piperidine-1,4-diyl, naphthalene-2,6-diyl, decahydronaphthalene-2,6-diyl, or 1,2,3,4-tetrahydronaphthalene-2,6-diyl, it being possible for all these groups to be unsubstituted, mono- or polysubstituted with L.

Especially preferred groups A¹ and A² are 1,4-phenylene which is optionally substituted in 2-, 3-, 5- and/or 6-position by L, trans-1,4-cyclohexylene, 2,6-dioxane-1,4-diyl, 3,5-dioxane-1,4-diyl, tetrahydropyrane-2,5-diyl and tetrahydropyrane-3,6-diyl.

L is preferably F, Cl, Br, I, CN, OH, NO₂, NCS, SF₅ or straight chain or branched alkyl, alkenyl, alkinyl, alkoxy, alkylcarbonyl, alkoxycarbonyl, alkylcarbonlyoxy, thioether, alkylsulfonyl, alkylsulfanyl, alkylsulfanylcarbonyl, aminoalkyl or aminodialkyl with 1 to 8 C atoms, wherein one or more H atoms are optionally substituted by F or Cl.

L is very preferably F, Cl, CN, OH, NO₂, CH₃, C₂H₅, OCH₃, OC₂H₅, COCH₃, COC₂H₅, COOCH₃, COOC₂H₅, SO₂CF₃, CF₃, OCF₃, OCHF₂ or OC₂F₅, in particular F, Cl, CN, CH₃, C₂H₅, OCH₃, COCH₃ or OCF₃, most preferably F, Cl, CH₃, OCH₃ or COCH₃.

Preferably the mesogenic group MG contains only monocyclic groups, very preferably one or two 5- or 6-membered rings.

A smaller group of preferred mesogenic groups MG is listed below. For reasons of simplicity, Phe in these groups is 1,4-phenylene, PheL is 1,4-phenylene that is substituted with 1 to 4 groups L as defined in formula I, Cyc is 1,4-cyclohexylene and Z has one of the meanings of Z¹ formula I. The list is comprising the following subformulae as well as their mirror images
-PheL-Z- II-1
-Cyc-Z- II-2
-PheL-Z-Phe-Z- II-3
-Phe-Z-PheL-Z- II-4
-PheL-Z-PheL-Z- II-5
-PheL-Z-Cyc-Z- II-6
-Cyc-Z-Cyc-Z- II-7
-Cyc-Z-PheL-Z- II-8

Z is independently in each occurrence preferably selected from —COO—, —OCO—, —CH₂CH₂— and a single bond.

Very preferably the mesogenic group MG is selected from the following formulae and their mirror images 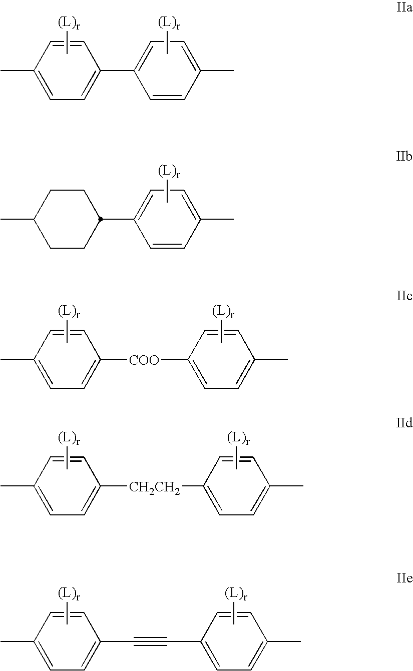
wherein L has the meanings given above, and r is 1, 2, 3 or 4, preferably 1 or 2.

The group 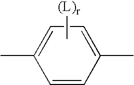
in these preferred formulae is very preferably denoting 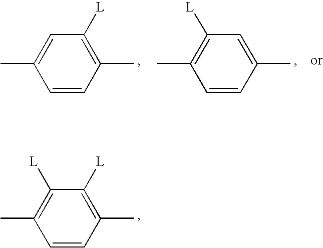
furthermore 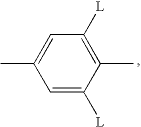
with L having each independently one of the meanings given above.

Especially preferred compounds of formula I comprise at least two groups 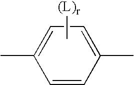
wherein r is 1 and/or at least one group 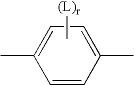
wherein r is 2.

If R is an alkyl or alkoxy radical, i.e. where the terminal CH₂ group is replaced by —O—, this may be straight-chain or branched. It is preferably straight-chain, has 2, 3, 4, 5, 6, 7 or 8 carbon atoms and accordingly is preferably ethyl, propyl, butyl, pentyl, hexyl, heptyl, octyl, ethoxy, propoxy, butoxy, pentoxy, hexoxy, heptoxy, or octoxy, furthermore methyl, nonyl, decyl, undecyl, dodecyl, tridecyl, tetradecyl, pentadecyl, nonoxy, decoxy, undecoxy, dodecoxy, tridecoxy or tetradecoxy, for example.

Oxaalkyl, i.e. where one CH₂ group is replaced by —O—, is preferably straight-chain 2-oxapropyl (=methoxymethyl), 2-(=ethoxymethyl) or 3-oxabutyl (=2-methoxyethyl), 2-, 3-, or 4-oxapentyl, 2-, 3-, 4-, or 5-oxahexyl, 2-, 3-, 4-, 5-, or 6-oxaheptyl, 2-, 3-, 4-, 5-, 6- or 7-oxaoctyl, 2-, 3-, 4-, 5-, 6-, 7- or 8-oxanonyl or 2-, 3-, 4-, 5-, 6-, 7-, 8- or 9-oxadecyl, for example.

If R is an alkyl group wherein one or more CH₂ groups are replaced by —CH═CH—, this may be straight-chain or branched. It is preferably straight-chain, has 2 to 10 C atoms and accordingly is preferably vinyl, prop-1-, or prop-2-enyl, but-1-, 2- or but-3-enyl, pent-1-, 2-, 3- or pent-4-enyl, hex-1-, 2-, 3-, 4- or hex-5-enyl, hept-1-, 2-, 3-, 4-, 5- or hept-6-enyl, oct-1-, 2-, 3-, 4-, 5-, 6- or oct-7-enyl, non-1-, 2-, 3-, 4-, 5-, 6-, 7- or non-8-enyl, dec-1-, 2-, 3-, 4-, 5-, 6-, 7-, 8- or dec-9-enyl.

Especially preferred alkenyl groups are C₂-C₇-1E-alkenyl, C₄-C₇-3E-alkenyl, C₅-C₇-4-alkenyl, C₆-C₇-5-alkenyl and C₇-6-alkenyl, in particular C₂-C₇-1E-alkenyl, C₄-C₇-3E-alkenyl and C₅-C₇-4-alkenyl.

Examples for particularly preferred alkenyl groups are vinyl, 1E-propenyl, 1E-butenyl, 1E-pentenyl, 1E-hexenyl, 1E-heptenyl, 3-butenyl, 3E-pentenyl, 3E-hexenyl, 3E-heptenyl, 4-pentenyl, 4Z-hexenyl, 4E-hexenyl, 4Z-heptenyl, 5-hexenyl, 6-heptenyl and the like. Groups having up to 5 C atoms are generally preferred.

If R is an alkyl group, wherein one CH₂ group is replaced by —O— and one by —CO—, these radicals are preferably neighboured. Accordingly these radicals together form a carbonyloxy group —CO—O— or an oxycarbonyl group —O—CO—. Preferably this group R is straight-chain and has 2 to 6 C atoms.

It is accordingly preferably acetyloxy, propionyloxy, butyryloxy, pentanoyloxy, hexanoyloxy, acetyloxymethyl, propionyloxymethyl, butyryloxymethyl, pentanoyloxymethyl, 2-acetyloxyethyl, 2-propionyloxyethyl, 2-butyryloxyethyl, 3-acetyloxypropyl, 3-propionyloxypropyl, 4-acetyloxybutyl, methoxycarbonyl, ethoxycarbonyl, propoxycarbonyl, butoxycarbonyl, pentoxycarbonyl, methoxycarbonylmethyl, ethoxycarbonylmethyl, propoxycarbonylmethyl, butoxycarbonylmethyl, 2-(methoxycarbonyl)ethyl, 2-(ethoxycarbonyl)ethyl, 2-(propoxy-carbonyl)ethyl, 3-(methoxycarbonyl)propyl, 3-(ethoxycarbonyl)propyl, 4-(methoxycarbonyl)-butyl.

If R is an alkyl group, wherein two or more CH₂ groups are replaced by —O— and/or —COO—, it can be straight-chain or branched. It is preferably straight-chain and has 3 to 12 C atoms. Accordingly it is preferably bis-carboxy-methyl, 2,2-bis-carboxy-ethyl, 3,3-bis-carboxy-propyl, 4,4-bis-carboxy-butyl, 5,5-bis-carboxy-pentyl, 6,6-bis-carboxy-hexyl, 7,7-bis-carboxy-heptyl, 8,8-bis-carboxy-octyl, 9,9-bis-carboxy-nonyl, 10,10-bis-carboxy-decyl, bis-(methoxycarbonyl)-methyl, 2,2-bis-(methoxycarbonyl)-ethyl, 3,3-bis-(methoxycarbonyl)-propyl, 4,4-bis-(methoxycarbonyl)-butyl, 5,5-bis-(methoxycarbonyl)-pentyl, 6,6-bis-(methoxycarbonyl)-hexyl, 7,7-bis-(methoxycarbonyl)-heptyl, 8,8-bis-(methoxycarbonyl)-octyl, bis-(ethoxycarbonyl)-methyl, 2,2-bis-(ethoxycarbonyl)-ethyl, 3,3-bis-(ethoxycarbonyl)-propyl, 4,4-bis-(ethoxycarbonyl)-butyl, 5,5-bis-(ethoxycarbonyl)-hexyl.

If R is an alkyl or alkenyl group that is monosubstituted by CN or CF₃, it is preferably straight-chain. The substitution by CN or CF₃ can be in any desired position.

If R is an alkyl or alkenyl group that is at least monosubstituted by halogen, it is preferably straight-chain. Halogen is preferably F or Cl, in case of multiple substitution preferably F. The resulting groups include also perfluorinated groups. In case of monosubstitution the F or Cl substituent can be in any desired position, but is preferably in 0-position. Examples for especially preferred straight-chain groups with a terminal F substituent are fluormethyl, 2-fluorethyl, 3-fluorpropyl, 4-fluorbutyl, 5-fluorpentyl, 6-fluorhexyl and 7-fluorheptyl. Other positions of F are, however, not excluded.

Halogen is preferably F or Cl.

R can be a polar or a non-polar group. In case of a polar group, it is selected from CN, SF₅, halogen, OCH₃, SCN, COR⁵, COOR⁵ or a mono- oligo- or polyfluorinated alkyl or alkoxy group with 1 to 4 C atoms. R⁵ is optionally fluorinated alkyl with 1 to 4, preferably 1 to 3 C atoms. Especially preferred polar groups are selected of F, Cl, CN, OCH₃, COCH₃, COC₂H₅, COOCH₃, COOC₂H₅, CF₃, CHF₂, CH₂F, OCF₃, OCHF₂, OCH₂F, C₂F₅ and OC₂F₅, in particular F, Cl, CN, CF₃, OCHF₂ and OCF₃. In case of a non-polar group, it is preferably alkyl with up to 15 C atoms or alkoxy with 2 to 15 C atoms.

R can be an achiral or a chiral group. In case of a chiral group it is preferably selected of formula III: 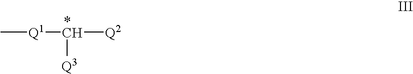
wherein
Q¹ is an alkylene or alkylene-oxy group with 1 to 9 C atoms or a single bond,
Q² is an alkyl or alkoxy group with 1 to 10 C atoms which may be unsubstituted, mono- or polysubstituted by F, Cl, Br or CN, it being also possible for one or more non-adjacent CH₂ groups to be replaced, in each case independently from one another, by —C≡C—, —O—, —S—, —NH—, —N(CH₃)—, —CO—, —COO—, —OCO—, —OCO—O—, —S—CO— or —CO—S— in such a manner that oxygen atoms are not linked directly to one another,
Q³ is F, Cl, Br, CN or an alkyl or alkoxy group as defined for Q² but being different from Q².

In case Q¹ in formula III is an alkylene-oxy group, the O atom is preferably adjacent to the chiral C atom.

Preferred chiral groups of formula III are 2-alkyl, 2-alkoxy, 2-methylalkyl, 2-methylalkoxy, 2-fluoroalkyl, 2-fluoroalkoxy, 2-(2-ethin)-alkyl, 2-(2-ethin)-alkoxy, 1,1,1-trifluoro-2-alkyl and 1,1,1-trifluoro-2-alkoxy.

Particularly preferred chiral groups are 2-butyl (=1-methylpropyl), 2-methylbutyl, 2-methylpentyl, 3-methylpentyl, 2-ethylhexyl, 2-propylpentyl, in particular 2-methylbutyl, 2-methylbutoxy, 2-methylpentoxy, 3-methylpentoxy, 2-ethylhexoxy, 1-methylhexoxy, 2-octyloxy, 2-oxa-3-methylbutyl, 3-oxa-4-methylpentyl, 4-methylhexyl, 2-hexyl, 2-octyl, 2-nonyl, 2-decyl, 2-dodecyl, 6-methoxyoctoxy, 6-methyloctoxy, 6-methyloctanoyloxy, 5-methylheptyloxycarbonyl, 2-methylbutyryloxy, 3-methylvaleroyloxy, 4-methylhexanoyloxy, 2-chlorpropionyloxy, 2-chloro-3-methylbutyryloxy, 2-chloro-4-methylvaleryloxy, 2-chloro-3-methylvaleryloxy, 2-methyl-3-oxapentyl, 2-methyl-3-oxahexyl, 1-methoxypropyl-2-oxy, 1-ethoxypropyl-2-oxy, 1-propoxypropyl-2-oxy, 1-butoxypropyl-2-oxy, 2-fluorooctyloxy, 2-fluorodecyloxy, 1,1,1-trifluoro-2-octyloxy, 1,1,1-trifluoro-2-octyl, 2-fluoromethyloctyloxy for example. Very preferred are 2-hexyl, 2-octyl, 2-octyloxy, 1,1,1-trifluoro-2-hexyl, 1,1,1-trifluoro-2-octyl and 1,1,1-trifluoro-2-octyloxy.

In addition, compounds containing an achiral branched group R may occasionally be of importance, for example, due to a reduction in the tendency towards crystallization. Branched groups of this type generally do not contain more than one chain branch. Preferred achiral branched groups are isopropyl, isobutyl (=methylpropyl), isopentyl (=3-methylbutyl), isopropoxy, 2-methyl-propoxy and 3-methylbutoxy.

The polymerizable or reactive group P is preferably selected from CH₂═CW¹—COO—, 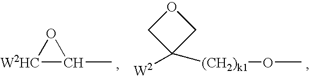
CH₂═CW²—(O)ₖ₁—, CH₃—CH═CH—O—, (CH₂═CH)₂CH—OCO—, (CH₂═CH—CH₂)₂CH—OCO—, (CH₂═CH)₂CH—O—, (CH₂═CH—CH₂)₂N—, HO—CW²W³—, HS—CW²W³—, HW²N—, HO—CW²W³—NH—, CH₂═CW¹—CO—NH—, CH₂═CH—(COO)ₖ₁-Phe-(O)ₖ₂—, Phe-CH═CH—, HOOC—, OCN—, and W⁴W⁵W⁶Si—, with W¹ being H, Cl, CN, phenyl or alkyl with 1 to 5 C-atoms, in particular H. C₁ or CH₃, W² and W³ being independently of each other H or alkyl with 1 to 5 C-atoms, in particular methyl, ethyl or n-propyl, W⁴, W⁵ and W⁶ being independently of each other Cl, oxaalkyl or oxacarbonylalkyl with 1 to 5 C-atoms, Phe being 1,4-phenylene and k₁ and k₂ being independently of each other 0 or 1.

Especially preferably P is a vinyl group, an acrylate group, a methacrylate group, an oxetane group or an epoxy group, especially preferably an acrylate or methacrylate group.

As for the spacer groups Sp¹ and Sp² all groups can be used that are known for this purpose to the skilled in the art.

The spacer group Sp¹ is preferably selected of formula IV1
Sp¹¹-X IV1
such that in formula I MG-Sp¹- denotes -MG-Sp¹¹-X-, wherein
Sp¹¹ is alkylene with 1 to 5 C atoms which may be unsubstituted, mono- or poly-substituted by F, Cl, Br, I or CN, it being also possible for one or more non-adjacent CH₂ groups to be replaced, in each case independently from one another, by —O—, —S—, —NH—, —NR⁰—, —SiR⁰R⁰⁰—, —CO—, —COO—, —OCO—, —OCO—O—, —S—CO—, —CO—S—, —CH═CH— or —C≡C— in such a manner that O and/or S atoms are not linked directly to one another, or a single bond,
X is —O—, —S—, —CO—, —COO—, —OCO—, —O—COO—, —CO—NR⁰—, —NR⁰—CO—, —OCH₂—, —CH₂O—, —SCH₂—, —CH₂S—, —CF₂O—, —OCF₂—, —CF₂S—, —SCF₂—, —CF₂CH₂—, —CH₂CF₂—, —CF₂CF₂—, —CH═N—, —N═CH—, —N═N—, —CH═CR⁰—, —CY¹═CY²—, —C≡C—, —CH═CH—COO—, —OCO—CH═CH— or a single bond, and
R⁰, R⁰⁰, Y¹ and Y² have one of the meanings given in formula I.

The spacer group Sp² is preferably selected of formula IV2
Sp²²-X IV2
such that in formula I P-Sp²- denotes P-Sp²²-X-, wherein
Sp²² is alkylene with 1 to 20 C atoms which may be unsubstituted, mono- or poly-substituted by F, Cl, Br, I or CN, it being also possible for one or more non-adjacent CH₂ groups to be replaced, in each case independently from one another, by —O—, —S—, —NH—, —NR⁰—, —SiR⁰R⁰⁰—, —CO—, —COO—, —OCO—, —OCO—O—, —S—CO—, —CO—S—, —CH═CH— or —C≡C— in such a manner that O and/or S atoms are not linked directly to one another, or a single bond,
and X, R⁰, R⁰⁰, Y¹ and Y² are as defined in formula IV1.

X is preferably —O—, —S—, —OCH₂—, —CH₂O—, —SCH₂—, —CH₂S—, —CF₂O—, —OCF₂—, —CF₂S—, —SCF₂—, —CH₂CH₂—, —CF₂CH₂—, —CH₂CF₂—, —CF₂CF₂—, —CH═N—, —N═CH—, —N═N—, —CH═CR⁰—, —CY¹═CY²—, —C≡C— or a single bond.

Typical groups Sp¹¹ are, for example, —(CH₂)ₚ₁—, —(CH₂CH₂O)_{q1}—, —CH₂CH₂—, —CH₂CH₂—S—CH₂CH₂— or —CH₂CH₂—NH—CH₂CH₂— or —(SiR⁰R⁰⁰—O)ₚ₁—, with p1 being an integer from 1 to 4, q1 being 1 or 2 and R° and R⁰⁰ having the meanings given above.

Typical groups Sp²² are, for example, —(CH₂)ₚ₂—, —(CH₂CH₂O)_{q2}—, —CH₂CH₂—, —CH₂CH₂—S—CH₂CH₂— or —CH₂CH₂NH—CH₂CH₂— or —(SiR⁰R⁰⁰—O)ₚ₂—, with p2 being an integer from 2 to 12, q2 being an integer from 1 to 3 and R° and R⁰⁰ having the meanings given above.

Preferred groups Sp¹¹ and Sp²² are ethylene, propylene, butylene, pentylene, hexylene, heptylene, octylene, nonylene, decylene, undecylene, dodecylene, octadecylene, ethyleneoxyethylene, methyleneoxybutylene, ethylene-thioethylene, ethylene-N-methyl-iminoethylene, 1-methylalkylene, ethenylene, propenylene and butenylene, for example.

Further preferred are compounds wherein Sp¹ or Sp¹¹ is a single bond.

Further preferred are compounds with one or two groups P-Sp²- wherein Sp² is a single bond. In case of compounds with two or more groups P-Sp², each of the polymerizable groups P and the spacer groups Sp² can be identical or different.

In another preferred embodiment the spacer group Sp²² is a chiral group of formula IV3: 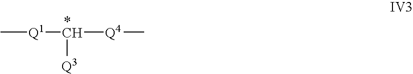
wherein
Q¹ and Q³ have the meanings given in formula II, and
Q⁴ is an alkylene or alkylene-oxy group with 1 to 10 C atoms or a single bond, being different from Q¹, with Q¹ being linked to the polymerizable group P.

Particularly preferred compounds of formula I are those of the following formulae

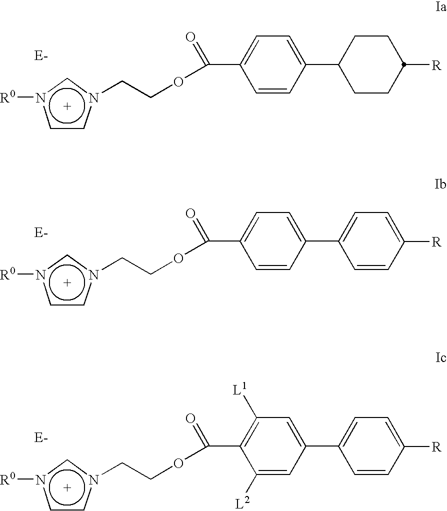

E⁻, R and R⁰ have one of the meanings of formula I or the preferred meanings given above, and L¹ and L² have one of the meanings of L given above.

In the above preferred formulae, R is preferably alkyl with 1 to 8 C atoms or P-Sp², R⁰ is preferably methyl or ethyl and L¹ and L² are preferably F.

The compounds according to the present invention can be synthesized according to or in analogy to methods which are known per se and which are described in standard works of organic chemistry such as, for example, Houben-Weyl, Methoden der organischen Chemie, Thieme-Verlag, Stuttgart. Some specific and preferred methods are described in the reaction schemes below. Further methods can be taken from the examples.

For the applications described above the LC media preferably contain at least one compound according to the present invention, and a nematic host mixture comprising one or more nematic or nematogenic compounds.

Preferably the LC media consist of 2 to 25, preferably 3 to 15 compounds, at least one of which is a compound according to the present invention. The other compounds, forming the nematic host mixture, are preferably low molecular weight LC compounds selected from nematic or nematogenic substances, for example from the known classes of the azoxybenzenes, benzylidene-anilines, biphenyls, terphenyls, phenyl or cyclohexyl benzoates, phenyl or cyclohexyl esters of cyclohehexanecarboxylic acid, phenyl or cyclohexyl esters of cyclohexylbenzoic acid, phenyl or cyclohexyl esters of cyclohexylcyclohexanecarboxylic acid, cyclohexylphenyl esters of benzoic acid, of cyclohexanecarboxylic acid and of cyclohexylcyclohexanecarboxylic acid, phenylcyclohexanes, cyclohexyl-biphenyls, phenylcyclohexylcyclohexanes, cyclohexylcyclohexanes, cyclohexylcyclohexenes, cyclohexylcyclohexylcyclohexenes, 1,4-bis-cyclohexylbenzenes, 4,4′-bis-cyclohexylbiphenyls, phenyl- or cyclohexylpyrimidines, phenyl- or cyclohexylpyridines, phenyl- or cyclohexylpyridazines, phenyl- or cyclohexyldioxanes, phenyl- or cyclohexyl-1,3-dithianes, 1,2-diphenyl-ethanes, 1,2-dicyclohexylethanes, 1-phenyl-2-cyclohexylethanes, 1-cyclohexyl-2-(4-phenylcyclohexyl)-ethanes, 1-cyclohexyl-2-biphenyl-ethanes, 1-phenyl2-cyclohexylphenylethanes, optionally halogenated stilbenes, benzyl phenyl ether, tolanes, substituted cinnamic acids and further classes of nematic or nematogenic substances. The 1,4-phenylene groups in these compounds may also be laterally mono- or difluorinated.

The most important compounds that are possible as components of these LC mixtures can be characterized by the following formula
R′-L′-G′-E-R″
wherein L′ and E, which may be identical or different, are in each case, independently from one another, a bivalent radical from the group formed by -Phe-, -Cyc-, -Phe-Phe-, -Phe-Cyc-, -Cyc-Cyc-, -Pyr-, -Dio-, -B-Phe- and -B-Cyc- and their mirror images, where Phe is unsubstituted or fluorine-substituted 1,4-phenylene, Cyc is trans-1,4-cyclohexylene or 1,4-cyclohexenylene, Pyr is pyrimidine-2,5-diyl or pyridine-2,5-diyl, Dio is 1,3-dioxane-2,5-diyl abd B is 2-(trans-1,4-cyclohexyl)ethyl, pyrimidine-2,5-diyl, pyridine-2,5-diyl or 1,3-dioxane-2,5-diyl.

G′ in these compounds is selected from the following bivalent groups —CH═CH—, —N(O)N—, —CH═CY—, —CH═N(O)—, —C≡C—, —CH₂—CH₂—, —CO—O—, —CH₂—O—, —CO—S—, —CH₂—S—, —CH═N—, —COO-Phe-COO— or a single bond, with Y being halogen, preferably chlorine, or —CN.

R′ and R″ are, in each case, independently of one another, alkyl, alkenyl, alkoxy, alkenyloxy, alkanoyloxy, alkoxycarbonyl or alkoxycarbonyloxy with 1 to 18, preferably 3 to 12 C atoms, or alternatively one of R′ and R″ is F, CF₃, OCF₃, Cl, NCS or CN.

In most of these compounds R′ and R″ are, in each case, independently of each another, alkyl, alkenyl or alkoxy with different chain length, wherein the sum of C atoms in nematic media generally is between 2 and 9, preferably between 2 and 7.

Many of these compounds or mixtures thereof are commercially available. All of these compounds are either known or can be prepared by methods which are known per se, as described in the literature (for example in the standard works such as Houben-Weyl, Methoden der Organischen Chemie [Methods of Organic Chemistry], Georg-Thieme-Verlag, Stuttgart), to be precise under reaction conditions which are known and suitable for said reactions. Use may also be made here of variants which are known per se, but are not mentioned here.

Another object the present invention is a polymerizable mixture comprising at least one ionic mesogenic or LC compound. A polymerizable LC mixture according to the present invention preferably comprises at least one polymerizable mesogenic compound having one polymerizable functional group and at least one polymerizable mesogenic compound having two or more polymerizable functional groups.

Polymerisable mesogenic mono-, di- and multireactive compounds used for the present invention can be prepared by methods which are known per se and which are described, for example, in standard works of organic chemistry such as, for example, Houben-Weyl, Methoden der organischen Chemie, Thieme-Verlag, Stuttgart.

Examples of suitable polymerizable mesogenic compounds that can be used as monomers or comonomers together with the compounds according to the present invention in a polymerizable LC mixture, are disclosed for example in WO 93/22397, EP 0 261 712, DE 195 04 224, WO 95/22586, WO 97/00600 and GB 2 351 734. The compounds disclosed in these documents, however, are to be regarded merely as examples that shall not limit the scope of this invention.

Examples of especially useful chiral and achiral polymerizable mesogenic compounds (reactive mesogens) are shown in the following lists which should, however, be taken only as illustrative and is in no way intended to restrict, but instead to explain the present invention:

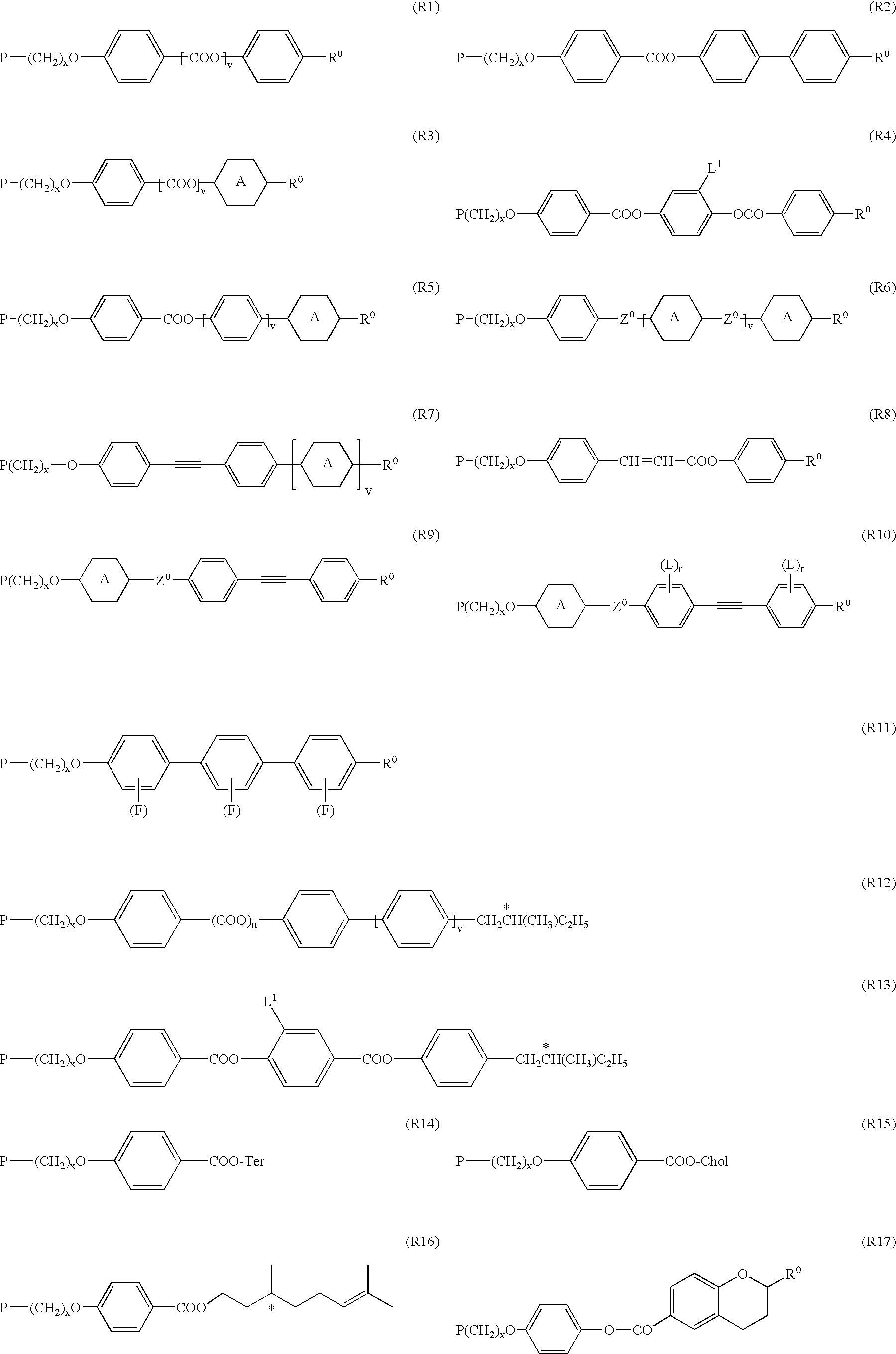

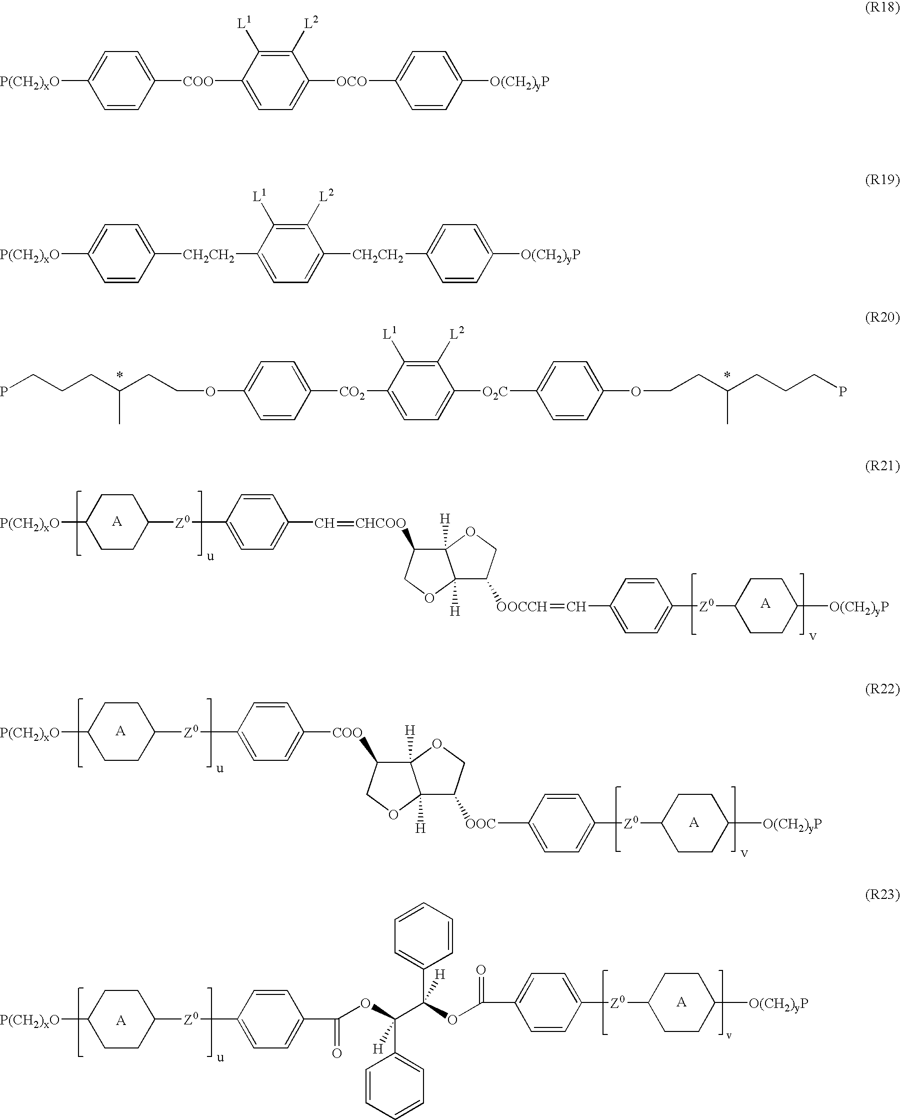

In the above formulae, P is a polymerisable group, preferably an acryl, methacryl, vinyl, vinyloxy, propenyl ether, epoxy, oxetane or styryl group, x and y are identical or different integers from 1 to 12, A is 1,4-phenylene that is optionally mono-, di- or trisubstituted by L¹, or 1,4-cyclohexylene, u and v are independently of each other 0 or 1, Z⁰ is —COO—, —OCO—, —CH₂CH₂—, —CH═CH—, —C≡C— or a single bond, R⁰ is a polar group or an unpolar group, Ter is a terpenoid radical like e.g. menthyl, Chol is a cholesteryl group, L, L¹ and L² are independently of each other H, F, Cl, CN or an optionally halogenated alkyl, alkoxy, alkylcarbonyl, alkylcarbonyloxy, alkoxycarbonyl or alkoxycarbonyloxy group with 1 to 7 C atoms, and r is 0, 1, 2, 3 or 4. The phenyl rings in the above formulae are optionally substituted by 1, 2, 3 or 4 groups L.

The term ‘polar group’ in this connection means a group selected from F, Cl, CN, NO₂, OH, OCH₃, OCN, SCN, an optionally fluorinated alkycarbonyl, alkoxycarbonyl, alkylcarbonyloxy or alkoxycarbonyloxy group with up to 4 C atoms or a mono- oligo- or polyfluorinated alkyl or alkoxy group with 1 to 4 C atoms. The term ‘unpolar group’ means an optionally halogenated alkyl, alkoxy, alkycarbonyl, alkoxycarbonyl, alkylcarbonyloxy or alkoxycarbonyloxy group with 1 or more, preferably 1 to 12 C atoms which is not covered by the above definition of ‘polar group’.

The polymerizable LC mixtures according to the present invention may also comprise one or more non-reactive chiral dopants in addition or alternatively to chiral polymerizable mesogenic compounds. Suitable chiral dopants can be selected e.g. from the commercially available R— or S-811, R— or S-1011, R— or S-2011, R— or S-3011, R— or S-4011, R— or S-5011, or CB 15 (from Merck KGaA, Darmstadt, Germany). Very preferred are chiral compounds with a high helical twisting power (HTP), in particular compounds comprising a sorbitol group as described in WO 98/00428, compounds comprising a hydrobenzoin group as described in GB 2,328,207, chiral binaphthyl derivatives as described in WO 02/94805, chiral binaphthol acetal derivatives as described in WO 02/34739, chiral TADDOL derivatives as described in WO 02/06265, and chiral compounds having at least one fluorinated linkage group and a terminal or central chiral group as described in WO 02/06196 and WO 02/06195.

To prepare anisotropic polymer films, the polymerizable LC mixture is preferably coated onto a substrate, aligned and polymerized in situ, for example by exposure to heat or actinic radiation, to fix the orientation of the LC molecules. Alignment and curing are carried out in the LC phase of the mixture. This technique is well-known in the art and is generally described for example in D. J. Broer, et al., Angew. Makromol. Chem. 183, (1990), 45-66.

Alignment of the LC material can be achieved for example by treatment of the substrate onto which the material is coated, by shearing the material during or after coating, by application of a magnetic or electric field to the coated material, or by the addition of surface-active compounds to the LC material. Reviews of alignment techniques are given for example by 1. Sage in “Thermotropic Liquid Crystals”, edited by G. W. Gray, John Wiley & Sons, 1987, pages 75-77, and by T. Uchida and H. Seki in “Liquid Crystals—Applications and Uses Vol. 3”, edited by B. Bahadur, World Scientific Publishing, Singapore 1992, pages 1-63. A review of alignment materials and techniques is given by J. Cognard, Mol. Cryst. Liq. Cryst. 78, Supplement 1 (1981), pages 1-77.

Polymerization takes place by exposure to heat or actinic radiation. Actinic radiation means irradiation with light, like UV light, IR light or visible light, irradiation with X-rays or gamma rays or irradiation with high energy particles, such as ions or electrons. Preferably polymerization is carried out by UV irradiation at a non-absorbing wavelength. As a source for actinic radiation for example a single UV lamp or a set of UV lamps can be used. When using a high lamp power the curing time can be reduced. Another possible source for actinic radiation is a laser, like e.g. a UV laser, an IR laser or a visible laser.

Polymerization is preferably carried out in the presence of an initiator absorbing at the wavelength of the actinic radiation. For example, when polymerizing by means of UV light, a photoinitiator can be used that decomposes under UV irradiation to produce free radicals or ions that start the polymerization reaction. When curing polymerizable materials with acrylate or methacrylate groups, preferably a radical photoinitiator is used, when curing polymerizable materials with vinyl, epoxide and oxetane groups, preferably a cationic photoinitiator is used. It is also possible to use a polymerization initiator that decomposes when heated to produce free radicals or ions that start the polymerization. As a photoinitiator for radical polymerization for example the commercially available Irgacure 651, Irgacure 184, Darocure 1173 or Darocure 4205 (all from Ciba Geigy AG) can be used, whereas in case of cationic photopolymerization the commercially available UVI 6974 (Union Carbide) can be used.

The polymerizable material can additionally comprise one or more other suitable components such as, for example, catalysts, sensitizers, stabilizers, inhibitors, chain-transfer agents, co-reacting monomers, surface-active compounds, lubricating agents, wetting agents, dispersing agents, hydrophobing agents, adhesive agents, flow improvers, defoaming agents, deaerators, diluents, reactive diluents, auxiliaries, colourants, dyes or pigments.

The compounds, LC media and poylmers according to the present invention can be used in liquid crystal displays and devices. They are epsecially suitable for use in devices based on the Kerr effect, like for example displays using liquid crystals in the isotropic state, hereinafter shortly referred to as “isotropic mode display”, as described for example in DE 102 172 73 and WO 02/93244 A1.

Thus, another object of the present invention is a display of the isotropic mode comprising at least one ionic compound according to the present invention, which is preferably a compound of formula I or of the preferred compounds shown above and below, or comprising an LC medium according to the present invention.

Furthermore, the compounds, LC media and polymers according to the present invention can be used for electrochemical applications, like for example electrolyte compositions, battery materials or electrochemical cells as described in EP 1 116 769 or EP 1 033 731, the entire disclosure of which is incorporated into this application by reference.

Thus, further objects of the present invention are an electrolyte medium comprising a ionic compound, LC medium or polymer as described above and below, and an electrochemical cell comprising a ionic compound or an electrolyte medium according to the present invention. The electrolyte media and electrochemical cells according to the present invention can comprise the components and be prepared by the methods described in EP 1 116 769 or EP 1 033 731.

Another field of use of the compounds and mixtures according to the present invention is as lubricants, optionally together with ionic liquids or other liquids and/or with oil. Such lubricants can be used for example in the application of fluid dynamic bearing units (FDBs) for use in hard disk drives (HDDs), which require low viscosity and low vapour pressure lubricants, and possibly some electrical conductivity to prevent static electricity.

The examples below serve to illustrate the invention without limiting it. In the foregoing and the following, all temperatures are given in degrees Celsius, and all percentages are by weight, unless stated otherwise. The following abbreviations are used to illustrate the liquid crystalline phase behaviour of the compounds: K=crystalline; N=nematic; S=smectic; S*=chiral smectic; N*, Ch=chiral nematic or cholesteric; I=isotropic. The numbers between these symbols indicate the phase transition temperatures in degree Celsius.

### EXAMPLE 1

Compound (1) was prepared as follows 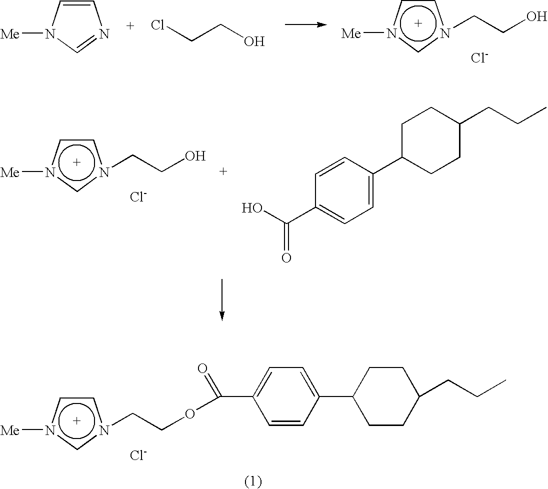
1a) Methyl Imidazolium Chloride

Chloroethanol (90.23 ml, 1.346 mol) was added to 1-methyl imidazole (100 ml, 1.224 mol) and stirred under reflux at 80° C. for 24 h. The flask was allowed to cool and a viscous oil formed, which was washed with diethyl ether to remove any remaining starting materials.

The residue was then evaporated to dryness on a rotary evaporator to give a viscous oil (86%).

This material was used without further purification in the following reactions.

1b)

Methyl imidazolium chloride (10.0 g, 0.061 mol) was added to a solution of dicyclohexylcarbodiimide (12.59 g, 0.061 mol) and dimethylaminopyridine (0.1 g) in anhydrous dichloromethane (150 ml). 4-4′-Propylcyclohexylbenzoic acid (15.03 g, 0.061 mol) was added and the solution was stirred at room temperature for 16 hours. A precipitate was removed by filtration, the filtrate was evaporated to dryness to leave a white residual solid. The residue was recrystallised three times from hot acetonitrile to give (1).

Optical Microscopy: K 158 S_{A} 220 I

### EXAMPLE 2

Compound (2) was prepared in analogy to the procedure described in example 1.

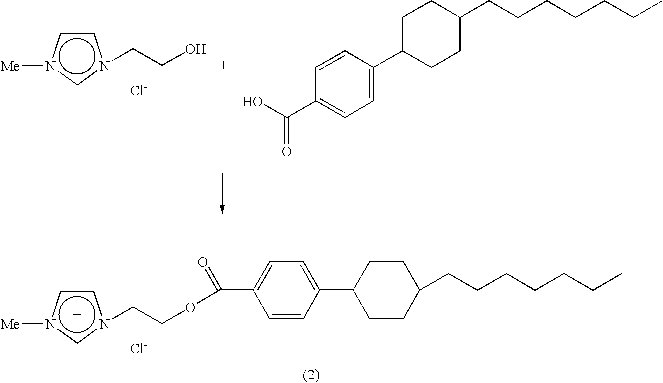

Optical Microscopy: K 131 S_{A} 244 I

### EXAMPLE 3

Compound (3) was prepared in analogy to the procedure described in example 1.

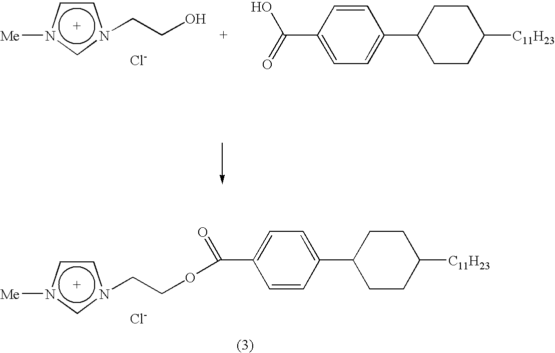

Optical Microscopy: K 50 S_{A} 23.8 I

### EXAMPLE 4

Compound (4) was prepared in analogy to the procedure described in example 1.

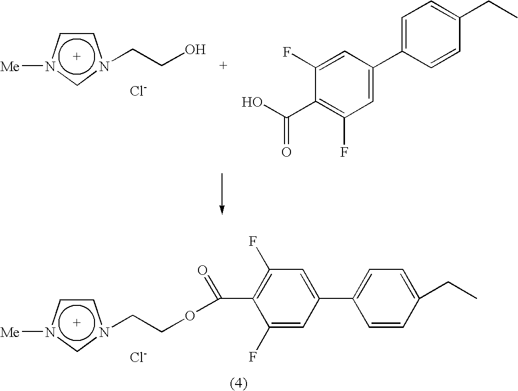

Optical Microscopy: K 229 I

### EXAMPLE 5

Compound (5) was prepared as follows

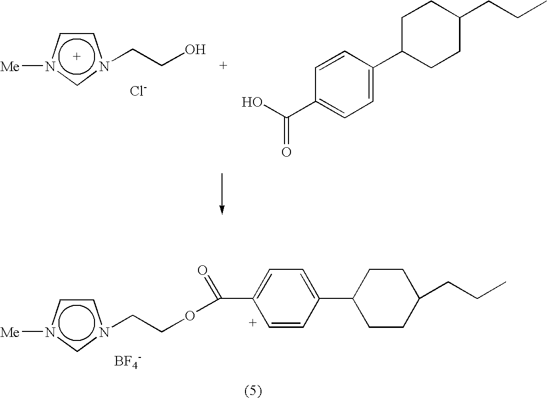

The ionic liquid crystal (2.0 g, 0.005 mol) was dissolved in anhydrous tetrahydrofuran, ammonium tetrafluoroborate (0.524 g, 0.005 mol) was added dropwise. The solution was stirred under nitrogen at room temperature for 3 hours. The solution was evaporated to dryness and recrystallised from hot acetonitrile three times to give (5) as a white crystalline solid.

Optical Microscopy: K 167 I

### EXAMPLE 6

Compound 6 was prepared in analogy to the procedure described in example 1.

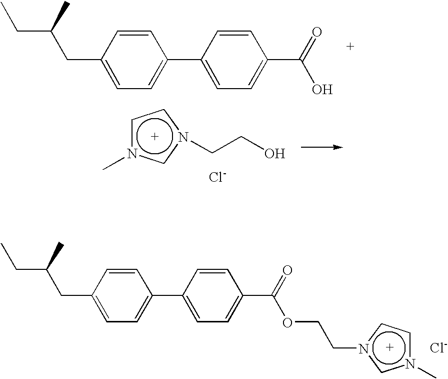

Optical Microscopy:

Wax softens 48 planar SA* 179 homeotropic S_{A}* 199 I

1. Ionic mesogenic or ionic liquid crystalline (LC) compounds comprising at least one organic cation D⁺ that is linked to a mesogenic group MG, optionally via a spacer group Sp¹, or is part of a mesogenic group.

2. Compounds according to claim 1, selected of formula I
R-MG-Sp¹-D⁺E⁻ I
wherein
D⁺ is an organic cation,
E⁻ is an anion,
MG is a mesogenic group,
Sp¹ is a spacer group or a single bond,
R is H, F, Cl, Br, I, CN, NO₂, NCS, SF₅ or alkyl which is straight chain or branched, has 1 to 20 C-atoms, is unsubstituted, mono- or polysubstituted by F, Cl, Br, I or CN, and in which one or more non-adjacent CH₂ groups are optionally replaced, in each case independently from one another, by —O—, —S—, —NH—, —NR⁰—, —SiR⁰R⁰⁰—, —CO—, —COO—, —OCO—, —OCO—O—, —S—CO—, —CO—S—, —CY¹═CY²— or —C≡C— in such a manner that O and/or S atoms are not linked directly to one another, or denotes P-Sp²,
R⁰ and R⁰⁰ are independently of each other H or alkyl with 1 to 12 C-atoms,
Y¹ and Y² are independently of each other H, F, Cl or CN,
P is a polymerizable or reactive group,
Sp² is a spacer group or a single bond.

3. Compounds according to claim 1, characterized in that the cation D⁺ is selected from the following formulae 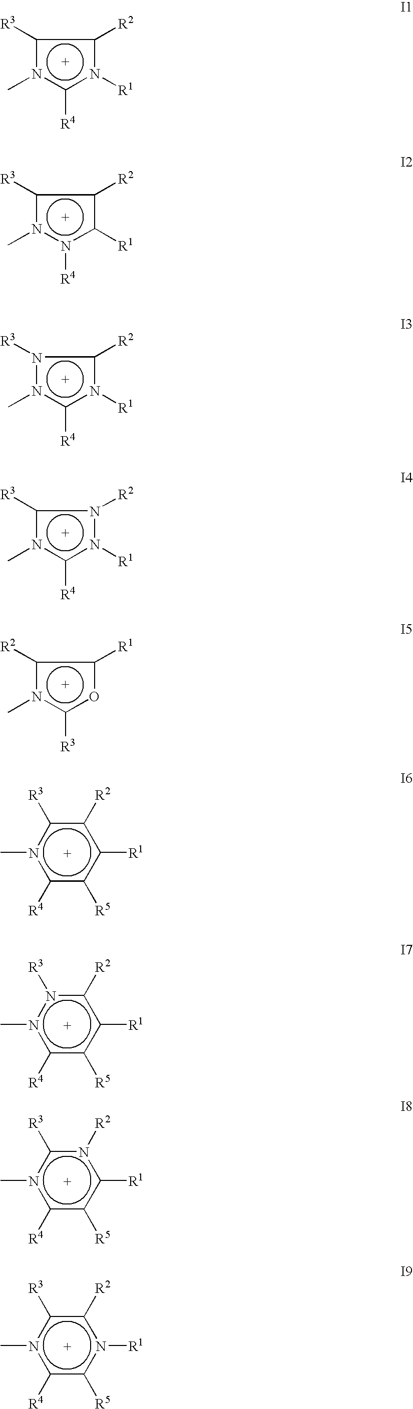
wherein R¹ to R⁵ are each independently of each other, H, F, Cl, Br, I, CN, NO₂, NCS, SF₅ or alkyl which is straight chain or branched, has 1 to 20 C-atoms, is unsubstituted, mono- or polysubstituted by F, Cl, Br, I or CN, and in which one or more non-adjacent CH₂ groups are optionally replaced, in each case independently from one another, by —O—, —S—, —NH—, —NR⁰, —SiR⁰R⁰⁰—, —CO—, —COO—, —OCO—, —OCO—O—, —S—CO—, —CO—S—, —CY¹═CY²— or —C≡C— in such a manner that O and/or S atoms are not linked directly to one another, or denotes P-Sp²,
P is a polymerizable or reactive group,
Sp² is a spacer group or a single bond.

4. Compounds according to claim 2, characterized in that the anion E⁻ is selected from the group comprising F⁻, Cl⁻, Br⁻, I⁻, I₃⁻, CH₃COO—, CF₃COO—, CF₃(CF₂)₃COO⁻, lactate, NO₃⁻, [(CF₃SO₂)₂N]⁻, [(CF₃CF₂SO₂)₂N]⁻, CF₃SO₃—, [CF₃(CF₂)₃SO₃]⁻, [(CF₃SO₂)₃C]⁻, PF₆⁻, AsF₆⁻, SbF₆⁻, BF₄B⁻, ClO₄⁻, [P(CₙF₂ₙ₊₁)₆₋ₓFₓ]⁻, Ph₄B⁻ and [(CₙH₂ₙ₊₁)₄B]⁻ wherein x is an integer from 1 to 6 and Ph is phenyl.

5. Compounds according to claim 2, characterized in that the mesogenic group MG is selected of formula II
-(A²-Z²)-A¹-Z¹- II
wherein
A¹ and A² are independently of each other an aromatic or alicyclic group, or a group comprising two or more fused aromatic or alicyclic rings, wherein these rings optionally contain one or more hetero atoms selected from N, O and S, and are optionally mono- or polysubstituted by R,
Z¹ and Z² are independently of each other —O—, —S—, —CO—, —COO—, —OCO—, —S—CO—, —CO—S—, —O—COO—, —CO—NR⁰—, —NR⁰—CO—, —OCH₂—, —CH₂O—, —SCH₂—, —CH₂S—, —CF₂O—, —OCF₂—, —CF₂S—, —SCF₂—, —CH₂CH₂—, —CF₂CH₂—, —CH₂CF₂—, —CF₂CF₂—, —CH═N—, —N═CH—, —N═N—, —CH═CR⁰—, —CY¹═CY²—, —C≡C—, —CH═CH—COO—, —OCO—CH═CH— or a single bond,
m is 0, 1, 2 or 3.

6. Compounds according to claim 2, characterized in that the mesogenic group MG comprises at least two monocyclic groups or at least one bicyclic group comprising at least two fused rings.

7. Compounds according to claim 2, characterized in that the mesogenic group MG is selected from the following formulae and their mirror images 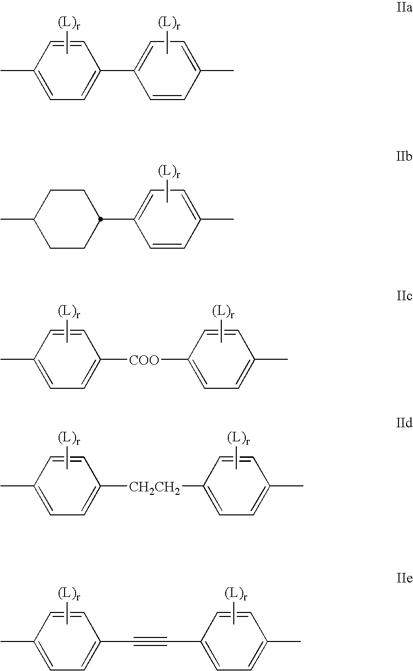
wherein L has one of the meanings of R in claim 2 and r is 1, 2, 3 or 4.

8. Compounds according to claim 2, characterized in that they are selected from the following formulae 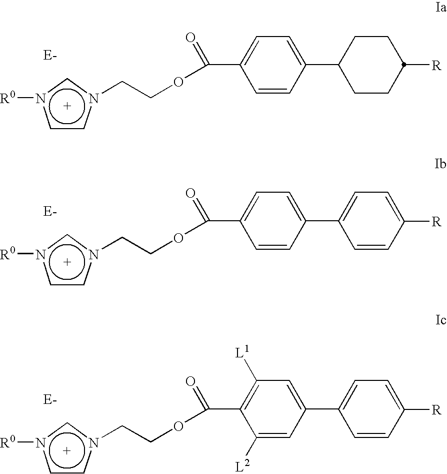
wherein E⁻, R and R⁰ have one of the meanings of claim 2, and L¹ and L² have one of the meanings of R given in claim 2.

9. Compounds according to claim 1, characterized in that they they comprise at least one polymerizable group.

10. Liquid crystal medium, characterized in that it comprises at least one compound according to claim 1.

11. Polymerizable liquid crystal medium, characterized in that it comprises at least one compound according to claim 1 and at least one polymerizable mesogenic compound, which can be said compound of claim 1 and/or an additional compound.

12. Polymer obtained by polymerizing a compound according to claim 1.

13. Anisotropic polymer film obtained by polymerizing a compound or medium according to claim 1 in its oriented state.

14. Use of a compound, medium, polymer or polymer film according to claim 1 in electrooptical displays, liquid crystal displays, optical films, polarizers, compensators, beam splitters, reflective films, alignment layers, colour filters, holographic elements, hot stamping foils, coloured images, decorative or security markings e.g. for consumer objects or documents of value, LC pigments, adhesives, synthetic resins with anisotropic mechanical properties, cosmetics, diagnostics, nonlinear optics, optical information storage, as chiral dopants, in electronic devices like for example field effect transistors (FET) as components of integrated circuitry, as thin film transistors in flat panel display applications or for Radio Frequency Identification (RFID) tags, or in semiconducting components for organic light emitting diode (OLED) applications, electroluminescent displays or backlights of LCDs, for photovoltaic or sensor devices, in lasing applications and devices, as electrolyte materials, in electrochemical cells or batteries, as photoconductors, for electrophotographic applications or electrophotographic recording or as lubricants.

15. Liquid crystal device comprising a compound, LC medium, polymer or polymer film according to claim 1.

16. Liquid crystal device utilizing the Kerr effect comprising a compound, LC medium, polymer or polymer film according to claim 1.

17. Electrolyte medium comprising a compound, LC medium or polymer according to claim 1.

18. Electrochemical cell comprising a compound, LC medium or polymer according to claim 1.

19. Polymer medium obtained by polymerizing a compound according to a liquid crystal medium according to claim 11.

20. Electrochemical cell comprising an electrolyte medium according to claim 17.
